(19) United States
(12) Patent Application Publication
(10) Pub. No.: US 2015/0205065 A1
(43) Pub. Date: Jul. 23, 2015

(54) Optical fiber cable filling compositions compatible with polypropolene type sheath and cable containing the same

(71) Applicant: Alvin C. Levy, Atlanta, GA (US)

(72) Inventor: Alvin C. Levy, Atlanta, GA (US)

(21) Appl. No.: 13/998,726

(22) Filed: Nov. 29, 2013

(51) Int. Cl. G02B 6/44; C08L 25/08

(52) U.S. Cl. CPC G02B 6/4494; C08L 25/08

(57) ABSTRACT

The instant invention relates to a thixotropic gel composition useful for filling optical fiber cable and the cable containing the composition. The composition is compatible with all sheath materials commonly used in the tubes containing the fiber including polypropylene copolymer with ethylene. The composition requires no fumed silica and minimizes the addition level of the costly high molecular weight polyalphaolefin oil commonly used where compatibility with polypropylene copolymer is required. The composition contains about 7.5% to 11% by weight styrene/ethylene-propylene di-block rubber, 52% to 92% by weight of a polyalphaolefin oil or oil mixture and 0.1% to 2% by weight of an antioxidant. Where compatibility of the polyalphaolefin oil with polypropylene copolymer is desired, the number average molecular weight of the oil should be greater than about 800. To minimize the amount of di-block rubber necessary to form the thixotropic network, the weight average molecular weight of the oil should be less than about 1400. Up to 30% by weight of a polybutene oil having a number average molecular weight between 900 and 1300 can be added to reduce cost or to provide sites for hydrogen absorption.

### BACKGROUND OF THE INVENTION

The present invention relates to optical fiber cables incorporating unique performance and cost effective filling compositions wherein these compositions are compatible with the polypropylene and polypropylene copolymer with ethylene sheath surrounding the fibers.

An optical fiber is comprised of a glass fiber surrounded by two organic coatings. The filling composition, generally referred to in the industry as a filling compound or gel, is used to fill the voids in the cable that exist between the optical fibers and the thermoplastic tube or sheath containing the optical fibers. The purpose of the filling composition is to prevent ingress of water into sheath containing the optical fibers. Exposure of the optical fiber to water can lead to degradation of fiber strength and to attenuation of the transmission signal.

Telecommunications cables are generally designed to last twenty years. During this period the cable may be exposed to temperatures as low as −40° C. and as high as 80° C. Just as water can degrade cable performance, the filling compound can also cause problems if over its design life it should degrade the mechanical properties of thermoplastic sheath and/or the fiber coatings. Other properties specific to the gel that are important include thermal oxidative stability, oil separation, stiffness and cost.

If the filling compound is too stiff, small deflections in the axis of the glass fiber introduced in cable manufacture, handling or environmental exposure cannot dissipate thereby causing signal attenuation. These small deflections that are the order of the wavelength of light are referred to as microbends. If the filling compound is not stiff enough, it may flow out of the cable. The permissible ranges of these properties will depend upon the cable design and material used in cable manufacture. However, there are principles that apply independent of cable design.

The physical property related to filling compound stiffness is critical yield stress. Critical yield stress is discussed in U.S. Pat. No. 4,701,016. If the critical yield stress is too high, signal attenuation due to “microbending” will result. The stiffness and therefore attenuation is greatest at −40° C. A preferred critical yield stress below 35 Pa at 20° C. is disclosed in U.S. Pat. No. 4,701,016 for the gel compositions in a ribbon cable design. Note, this stress level is specific to that cable design and that gel composition because the critical yield stress cannot be easily measured at −40° C. To assure performance at −40° C., the penetration per ASTM D217 is measured. Commercial filling compounds described in U.S. Pat. No. 5,276,757 have been successfully used in cable manufacture. These compounds are listed in that patent as having a penetration of about 200 dmm at −40° C. Also see T. Hattori et al., Proceedings of the International Wire and Cable Symposium, 12-15 (1988).

As previously stated, if the critical yield stress is too low the gel will flow out of the cable. Flow out of the cable is most likely to occur at 80° C. The critical yield stress required for the gel to remain in a specific tube diameter can be calculated and the critical yield stress can be measured at 80° C.

Thermal oxidative stabilization of the filling compound is easy to attain with the antioxidants described in the prior referenced patents as long as the degree of unsaturation of the organic components is limited.

There are two different oil separation test methods. In one such test, the filling compound is subjected to a centrifugal force of 27,000 g for two hours at 25+/−2° C. Oil separation must not exceed 2% to pass this test (U.S. Pat. No. 6,160,939). This centrifuge method is commonly used with gels that use fumed silica to form the thixotropic network. U.S. Pat. No. 4,810,395 discusses the inclusion of a styrene-rubber diblock copolymer in the filling composition to reduce oil separation.

In second method, ASTM D6184, compound is placed inside a small conical vessel formed from metal screening. The cone containing the compound is then placed inside an oven at elevated temperature. There does not appear to be an industry standard for the test temperature or time. The test times vary from 24 to 48 hours at temperatures ranging from 80° C. to 150° C. The oil separation and volatile weight loss are determined at the conclusion of the holding period.

Tube or sheath materials include polyethylene (PE), polypropylene (PP), polypropylene polyethylene copolymer with ethylene (PPCP) where the major component is polypropylene and polybutylene terephthalate (PBT). PBT is much more costly than the PP and PPCP resins. U.S. Pat. No. 6,085,009 describes how most commercially filling compounds (Henkel CF300 and CF260, Astor Rheogel 250 and Huber LA444) that work well with PBT unacceptably swell the PP and PPCP type resins. That patent further describes compounds that work well with PP and PPCP resins. Such compounds are comprised of polyolefin oils with only a small molecular weight fraction below 2000, a thixotropic agent and a thermal oxidation stabilizer.

Compounds conforming to this description are described in U.S. Pat. No. 5,276,757. These compounds are comprised of high molecular weight poly n-decene and polybutene oils, fumed silica and an antioxidant. Further compounds conforming to this description are described in U.S. Pat. No. 5,187,763. These latter compounds are comprised of high molecular weight poly n-decene oil which is a type of polyalphaolefin (PAO), a styrene-ethylene propylene di-block copolymer rubber (SEP), fumed silica and an antioxidant. Unfortunately PP and PPCP compatible compounds described in the prior art are costly relative to compounds that are only PBT compatible. By incompatible, it is meant that the filling compound unacceptable swells the sheath, thereby compromising cable performance. One primary objective of this work is to develop a cost effective filling compound which is compatible with PP and PPCP sheath materials.

The prior art also knows other filling compositions not previously referenced. U.S. Pat. Nos. 5,737,469, 6,160,939, and No. 7,253,217 B2 disclose materials comprised of oils and SEP that require no fumed silica to form the gel. U.S. Pat. Nos. 5,335,302 and 7,253,217 B2 disclose microsphere inclusion in the filling composition. U.S. Pat. No. 5,455,811 discloses a hydrogen-absorbing composition.

Of the various major components that comprise the filling compound, fumed silica is the most costly on a per pound basis. The SEP rubber is up to 50% lower in cost than the fumed silica depending on the type of fumed silica. In relationship to the PAO type oils, the SEP can be from 50% to 150% greater in cost depending on the molecular weight of the oil.

### SUMMARY OF THE INVENTION

The present invention satisfies the objective described herein. Additional advantages relative to high temperature applications outside the range of telecommunication cable design parameters are also described herein.

The present invention comprises a gel composition based on PAO oils and SEP rubber that is compatible with PE, PPCP and PBT sheath materials and is useful in filling the voids between the fibers in an optical fiber cable.

In order to insure gel compatibility with the most sensitive of sheath materials PPCP, the number average molecular weight (Mn) of the PAO oil or mixture of oils should be greater than about 800. Where SEP is used as the thixotrope, the weight average molecular weight (Mw) of the PAO oil or mixture of oils should be less than about 1400. As Mw of the PAO oil increases, the effectiveness of SEP in forming the gel network decreases. As a result, additional SEP must be included in the gel composition to maintain a desired critical yield stress. Inclusion of additional SEP will increase the material cost of the gel.

The preferred PAO oil should have an Mn of about 800 to 900 and an Mw less than about 1000. However since such oils are not commercially available, blends of PAO oils with Mn between 600 and 720 and a polydispersity of about 1.05 are blended with much higher molecular weight PAO oils (Mn about 1750 and Mw about 2800) to meet the Mn and Mw requirements.

Two SEP rubbers are commercially available, one having an S/EP weight ratio of 37/63 and one with an S/EP ratio of 28/72. For a given critical yield stress, compositions using the 28/72 S/EP ratio rubber require about 15% less SEP than the 37/63 S/EP ratio rubber. The useful content of SEP in the gel composition is about 7.5 to 11% by weight. The specific content will depend on the desired critical yield stress of the gel, the choice of commercial rubber, the Mw of the PAO oil, and desired high temperature flow properties of the gel.

The gel composition also contains an antioxidant and optionally up to about 30% of a polybutene (PB) oil with an Mn of about 900 to 1300. The function of the PB oil is to reduce cost and/or to provide sites for hydrogen absorption

The composition may also include a fungicide, the amount usually not more than 0.1% by weight. A catalyst such as palladium on charcoal at about 0.25% by weight may be included to accelerate hydrogen absorption in gels containing PB oil. Hollow microspheres may also be added to decrease the composition density.

A second aspect of this invention is the cable containing the optical fibers wherein the voids between the optical fibers are occupied by the said filling composition.

Another aspect of this invention is filling composition for a cable or probe designed for operation at temperatures considerably outside the range specified for telecommunications cable.

### BRIEF DESCRIPTION OF DRAWING

FIG. 1 is the graphical representation of the equilibrium weight gain at 80° C. of a 0.030 inch thick polypropylene homopolymer coupon after immersion in various PAO oils and oil gels. Weight gain is plotted versus 1000/Mn (oil number average molecular weight).

FIG. 2 is the graphical representation of the weight gain at 85° C. of a 0.125 inch thick polypropylene copolymer with ethylene test coupon after immersion in various PAO oils and gels. Weight gain is plotted versus 1000/Mn.

FIG. 3 is a graphical representation in which the critical yield stress at 23° C. and 80° C. of gel compositions is plotted as a function of Kraton G1701 content. The composition PAO oils have a number average molecular weight between 608 and 720.

FIG. 4 is a graphical representation in which the critical yield stress at 23° C. of gel compositions having 10% Kraton G1701 is plotted versus the Spectrosyn 40 oil content of the gel composition. The balance of the oil is Durasyn 168. Also plotted is the polypropylene homopolymer weight gain at 80° C. versus the same Spectrosyn 40 content.

FIG. 5 is a graphical representation in which the critical yield stress at 23° C. of gel compositions containing 10% Kraton G1701 is plotted as a function of the weigh average molecular weight of the PAO oil blends.

### DETAILED DESCRIPTION

The performance parameters for a filling composition include property requirements common to all cable designs. For example, the oxidative stability and the stiffness at low temperature requirements of the composition are common to all cable designs. These properties are well understood and are easily attained by using highly saturated oils with pour points no greater than about −40° C., or in the case of PB oils, a glass transition temperature no greater than −40° C.

The oil separation requirement for the gel is also common to all cable designs. This requirement is generally met by proper selection and balance of the gel formulation. Oil separation tendency of the gel increases with temperatures. Therefore it is important to test for oil separation at the upper temperature cable design parameter, 80° C.

In addition, there are gel properties where proper selection of the gel components are critical to the compatibility of the gel with the type of thermoplastic resin used to manufacture the sheath containing the fibers.

The inside diameter of that sheath and the manner in which the fibers are arrayed within the sheath are also important to the required critical yield stress of the filling composition. As the sheath inside diameter increases, the critical yield stress of the gel must also increase if the gel is to remain inside the cable. The critical yield stress will decrease as the exposure temperature increases. The required critical yield stress can be calculated from the density (DEN) of the gel and the inside diameter (ID) of the sheath by the formula

Critical Yield Stress=(DEN)(ID)/4.

One common sheath design is often referred to as a loose buffer tube. The tube may contain up to 12 fibers and is usually not greater than about 3 mm in diameter. In a second design called the ribbon cable design, six or twelve fibers are bonded in a flat array called a ribbon. The ribbons are then stacked to obtain large fiber count cables. The stacked arrays are packaged in either a loose tube or slotted core geometry. The diameter of the tubes containing the ribbons is much greater than in loose buffer tube.

The protocol used in this work was first to select and obtain a set of materials or components for use in the inventive process. The composition components included the oils, rubbers and antioxidants used to formulate the gel. In addition various types of sheath materials were obtained for used in compatibility testing.

The oils along with typical properties are shown in TABLE I. Oils A, B, C, D, G and H are hydrogenated poly n-decenes. F is a hydrogenated poly n-dodecene oil and E is a mixture of hydrogenated oils including C14. All of these oils are included under the broad classification of polyalphaolefin. Oils J is a polybutene (PB) and is not hydrogenated.

TABLE I
Summary of Synthetic Oils Evaluated

| | | | | Pour | Visc., |
|---|---|---|---|---|---|
| | TRADE | | | Point, ° C. | cSt @ 100° C. |
| OIL | NAMEa,b | Mn | Mw/Mn | ASTM D 97 | ASTM D 445 |
| A | Spectrosyn 6 | 544 | 1.04 | −57 | 5.84 |
| B | Spectrosyn 8 | 641 | 1.04 | −54, −51 | 7.95, 8.08 |
| C | Spectrosyn 10 | 720 | 1.05 | −48 | 10.5 |
| D | Spectrosyn 40 | 1758 | 1.55 | −42 | 39.4 |
| E | Durasyn 128 | 639 | 1.03 | −35 | 7.94 |
| F | Durasyn 148 | 640 | 1.03 | −42 | 7.6 |
| G | Durasyn 168 | 609 | 1.03 | −51 | 7.78 |
| H | Durasyn 170 | 663 | 1.04 | −57 | 9.6 |
| I | Durasyn 174i | 1723 | 1.5 | −39 | 50.6 |
| J | Indopol H300 | 1300 | 1.65 | 3 | 630 |

aSpectrosyn ® is a Trade Name of ExxonMobil Chemical Company
bDurasyn ® and Indopol ® are Trade Names of INEOS Oligomers

The rubbers used in the study, Kraton G1701 and Kraton G1702, are products of Kraton Performance Polymers, Inc. Both are di-block materials having a styrene block (S) and an ethylene-propylene rubber block (EP). Kraton G1701 has a S/EP ratio of 37/63, a specific gravity of 0.92 and a Brookfield Viscosity, 25% w in toluene of >50,000 cps. Kraton G1702 has a S/EP ratio of 28/72, a specific gravity of 0.91, a viscosity, 25% w in toluene of 50,000 cps and a viscosity, 10% w in toluene of 280 cps.

There are many antioxidants that can be used. The two used herein are Irganox 1035 and Irganox 1076. Irganox is a trade name of BASF Corporation. Both materials are hindered phenols. The chemical names respectively are octadecyl 3-(3′,5′-di-tert-butyl-4′-hydroxyphenyl) propionate and thiodiethylene bis-(3,5-di-tertbutyl-4-hydroxy) hydrocinnamate.

Other components sometimes added to the gel include about 0.1% by weight fungicide such as 2-(4-thiazolyl)benzimidazole) to prevent fungus growth, hollow microspheres to reduce the gel density and a hydrogen catalyst such as 0.25% by weight palladiate charcoal with 5% palladium. Where the catalyst is included, the gel should contain an unsaturated component such as a polybutene oil to provide the sites necessary to react with the hydrogen.

Three polypropylene materials were evaluated for compatibility with the oils and gels.
1) Polypropylene homopolymer (PP1); 0.030 inch thick commercial sheet
2) Polypropylene homopolymer (PP2); stress relaxed 0.062 inch thick commercial sheet
3) Polypropylene copolymer with ethylene (PPCP); 0.125 inch thick, used as sheath resin when the ethylene copolymer content was about 8 to 10%.

The compatibility of the oils and gels containing the oils with the polypropylene materials was determined by immersing a polypropylene test coupon in an excess of the oil or gel. All test coupons within a given test series were the same size. The weight increase of the coupon was measured periodically. To be acceptable as a filling composition, the 30 day weight gain at 80° C. should be no more than about 7%.

PP1 and PP2 test coupons were evaluated at both 80° C. and 85° C. Equilibrium was attained in 15 days or less with PP1. PP2 required the full 30 days exposure period for all oils tested to reach equilibrium with the coupons. Since the time to equilibrium for PP1 was much shorter than that for PP2 or PPCP, PP1 was used for primary screening of the oils and gels.

Two different size coupon were used for PPCP; 0.125 in.×0.75 in.×2.1 in. (PPCP1), and 0.125 in.×0.50 in.×1.9 in. (PPCP2). PPCP1 coupons were immersed for 44 days at 80° C. Equilibrium had not been reached for PPCP1 after 44 days at 80° C. although the rate of rise in weight gain had decreased considerably. The difficulty in reaching equilibrium with the coupons at 80° C. is most likely related to the thickness of the test coupons. However, after an additional 33 days at 85° C., all coupons were either at or very close to equilibrium.

PPCP2 coupons were tested for 30 days at 80° C. using three oils. These data show a more rapid rise in weight gain than for PPCP1, most likely because PPCP2 has a much higher surface area to volume ratio than PPCP1. Weight gain data for all the coupons are given in Table II.

TABLE II
Weight Gain (%) of Polypropylenes in Various Oils and Gels
**after 44 da, @ 80° C.

| | | | PP1 | PP1 | PP2 | PP2 | PPCP1 | PPCP1 | PPCP1 | PPCP2 |
|---|---|---|---|---|---|---|---|---|---|---|
| OIL | GEL | OIL | @ 80° C. | @ 85° C. | @ 80° C. | @ 85° C. | @ 80° C. | @ 80° C. | @ 85° C. | @ 80° C. |
| ID | ID* | Mn | equil. | equil. | equil | equil | 30 da. | 44 da. | 33 da.** | equil. |
| A | | 544 | 7.5 | 7.6 | 5.9 | 6.4 | 9.1 | 10.5 | 14.5 | |
| B | | 641 | 6.7, 6.8 | | 5.2 | 5.6 | 6.5 | 7.6 | 11.2 | |
| C | | 720 | 6.0, 6.1 | 6.3 | 4.7 | 5.0 | 4.9 | 6.1 | 8.5 | |
| D | | 1758 | 3.9 | 3.9 | 2.2 | 2.6 | 1.1 | 1.4 | 2.2 | |
| E | | 639 | 6.8 | | | | | | | |
| F | | 640 | 6.9 | | | | | | | 7.5 |
| G | | 609 | 6.8, 6.5 | 7.1 | | | | | | |
| H | | 663 | 6.6 | | | | | | | 6.7 |
| 1 | | 1723 | 3.6 | | | | | | | |
| J | | 1300 | | 5.1 | | | | | | |
| B/D (50/50) | | 939 | 5.5 | | | | | | | 4.5 |
| G/J (80/20) | | | | 7.2 | | | | | | |
| G/J (60/40) | | | | 7.2 | | | | | | |
| B | 3 | 641 | 6.6 | | | | | | | |
| C | 5 | 720 | 6.1 | 6.2 | | 5.2 | | | | |
| B | 7 | 641 | 6.2 | | | | | | | |
| C | 10 | 720 | 6.4 | | | | | | | |
| G | 14 | 609 | 6.9 | | | | | | | |
| B | 15 | 641 | 6.6 | | | | | | | |
| C/J (80/20) | 17 | | 6.0 | | | | | | | |
| G/D (77/23) | 18 | 717 | 6.3 | | | | | | | |
| G/D (55/45) | 19 | 863 | 5.8 | | | | | | | |

*See Tables III, IV & V
**after 44 da. @ 80° C.

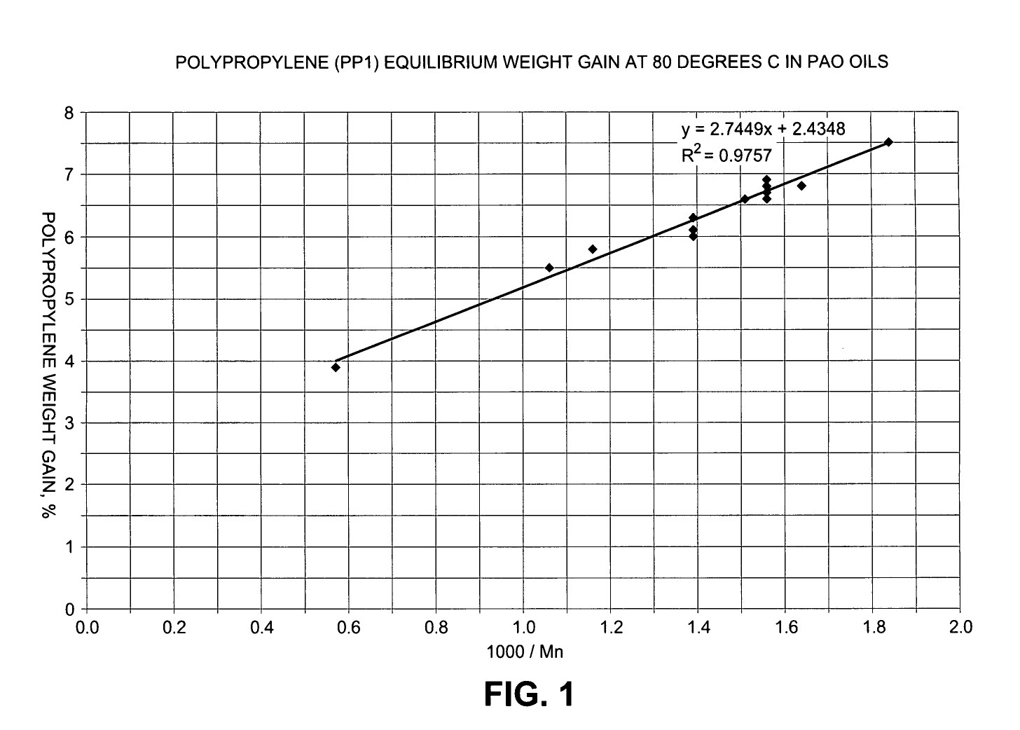

A number of observations can be made relative to the data in Table II. Reference to the PP1 data shows no difference in weight gain between the oils and the gels containing the oils. For the PAO oils and mixtures of PAO oils there is a strong inverse relationship between the weight gain and the number average molecular weight, Mn, of the oils and oil mixtures. The Mn for the mixtures is calculated from the Mn data for individual oil components. FIG. 1 shows the weight gain of PP1 plotted versus the reciprocal of Mn. Note in FIG. 1 the high correlation between the weight gain and the reciprocal of the Mn of the PAO oil or mixtures of PAO oil. For mixtures of PAO and PB oils, the weight gain is the same as that of the PAO oil.

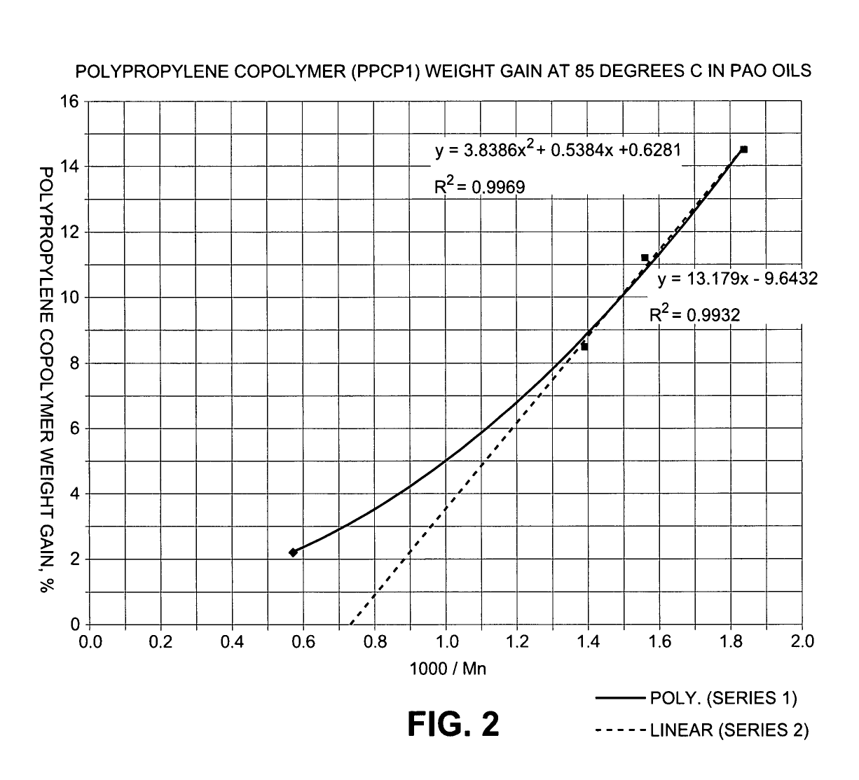

PP2 test coupons show similar behavior to PP1. However, because the coupons are thicker, 0.062 inch versus 0.030 inch for PP1, PP2 coupons take up to 30 days to reach equilibrium. Because of the sample thickness, 0.125 inch, PPCP1 did not reach equilibrium in 44 days at 80° C. After an additional 33 days at 85° C., equilibrium had either been reached or the rate of increase in coupon weight gain had slowed sufficiently to terminate the test. These 85° C. data are plotted in FIG. 2.

There are two plots of the data in FIG. 2, the first with oils A, B, C and D and a second that omits oil D. The distinction is made because oil D has a much higher polydispersity than the other oils. The First plot (Series 1) indicates that a minimum Mn of about 830 is required to have a maximum weight gain of 7% in PPCP. The second plot (Series 2) indicates a minimum Mn requirement of 790. For a 6% maximum weight gain the values of Mn are 840 and 890 respectively. Extrapolation of Series 2 data indicate that a PAO oil having an Mn of about 1100 and a Mw of about 1200 should give results similar to oil D.

Since PAO oils having a Mn of over 720 with a polydispersity of about 1.05 are not commercially available, blends of oils B and C with D are required to obtain an Mn in the desired range. Blending with D increases the raw cost of the gel composition and should be kept to a minimum.

A C/D weight ratio of 78/22 has an Mn of 830 and a 68/32 blend ratio has an Mn of 890. The respective values of Mw are 1184 and 1435.

A B/D weight ratio of 64/36 has an Mn of 830 and 56/44 ratio has an Mn of 890. The respective values of Mw are 1407 and 1572.

A number of different oil gels were prepared by mixing with Kraton G1701 and Kraton G1702 rubber. In the mix procedure, the blend components were first to allowed to sit for about two hours at room temperature. During this period, the oil swelled the rubber. The mixture was then heated to approximately 130° C. in an oven. The mix was periodically hand stirred. After the blend reached 130° C., mixing for an additional five minute was all that was required to form a uniform gel. The final mix was done by hand for the small volume blends and in a Ross LDM2 double planetary mixer under vacuum for the larger volume blends. The gel properties important to performance in the cable were then determined.

After the gel had fully cooled, the viscosity was determined using a Brookfield RVT viscometer with helipath stand and spindle TB at 0.5 rpm. The viscosity determined in this manner was stable and remained unchanged when measured days or weeks later.

The next gel property measured was critical yield stress. As previously discussed, the critical yield stress required for a gel to stay in a tube of a given inside diameter (ID) can be calculated where the density of the gel is known. For the small buffer of about 3 mm ID, the critical yield stress at 80° C. of the gels studied here should be no less than about 7 Pa. For a tube of about 0.30 inch ID, the critical yield stress should be no less than about 17 Pa.

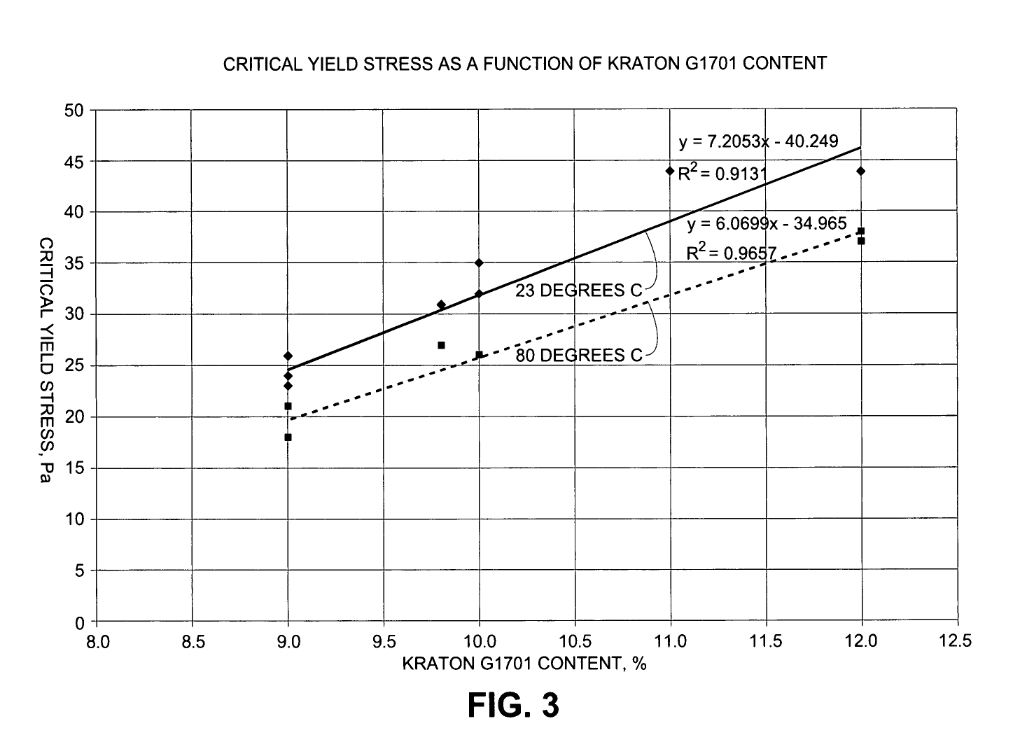

The critical yield stress at 23° C. and 80° C. of the gels was then measured using a Brookfield HBDV II+C/P viscometer, CP41, 0.1 rpm. The analog output of the viscometer was interfaced to a computer. A data analysis program was used to draw a tangent line to the initial linear portion of the stress/strain curve. The critical yield stress was recorded as the point where the curve first diverted from the tangent line. The critical yield stress data are given in Table III and are plotted in FIG. 3 as a function of Kraton G1701 content at both 23° C. and 80° C. The data show that for a given rubber content the critical yield stress decreases about 15% to 20% between 23° C. and 80° C. At 80° C., a Kraton G1701 level of approximately 9% is sufficient to yield a critical yield stress of 17 Pa.

TABLE III
Properties of Gels Containing Kraton ®^{a} G1701 Rubber and Synthetic Oils

| | FORMULA ID: | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Kraton ® G1701, % | 8.0 | 9.0 | 9.0 | 9.0 | 9.0 | 9.8 | 10.0 | 10.0 | 10.0 | 11.0 | 12.0 | 12.0 |
| Oil Type, % | C, 91.0 | A, 89.7 | B, 89.7 | C, 89.7 | C, 89.7 | C, 88.9 | B, 88.7 | F, 89.2 | G, 88.7 | C, 87.7 | C, 86.9 | B, 86.9 |
| Antioxidant, % | 1.0 | 1.3 | 1.3 | 1.3 | 1.3 | 1.3 | 1.3 | | | | | |
| T Bar Visc, Reading^{b} | 17 | 23.8 | 24.5 | 25 | 24.3 | 34.5 | 37.8 | 33.7 | 36.2 | 47.8 | 60.5 | 58 |
| @ RT | | | | | | | | | | | | |
| Crit. Yield Stress^{c}, Pa | | | | | | | | | | | | |
| @ 23° C. | 8 | 26 | 24 | 23 | 21 | 31 | 35 | 35 | 32 | 44 | 44 | 44 |
| @ 80° C. | | | 21 | 18 | 18 | 27 | 26 | | | | 37 | 38 |
| Oil Separation, % | | | | | | | | | | | | |
| ASTM D6184 | | | | | | | | | | | | |
| 30 hrs, @ 100° C. | | | | | 0 | | 0 | | | 0 | | |
| 24 hrs. @ 150° C. | | | | | 10.5 | | 0 | | | 0 | | |
| Screen Flow Test^{d} | | | | | | | | | | | | |
| Modified ASTM | | | | | | | | | | | | |
| D6184 | | | | | | | | | | | | |
| Pass, ° C. | | | | | 130 | | 170 | | | 180 | | |
| Fail, ° C. | | | | | 140 | | 178 | | | 190 | | |
| Screen Evap Test, % | | | | | 0.19 | | 0.29 | | | 0.18 | | |
| Modifed ASTM | | | | | | | | | | | | |
| D6184 | | | | | | | | | | | | |
| 24 hrs. @ 150° C. | | | | | | | | | | | | |
| PP1 Weiaht Gain, % | | | 6.6 | | 6.1 | | 6.2 | | | 6.4 | | |
| @ 80° C. | | | | | | | | | | | | |

^{a}Trade Name Kraton Polymers LLC
^{b}Brkfld RVT, TB, 0.5 RPM, Helipath
^{c}Brkfld HBDV II + C/P CP41, 0.1 RPM

The critical yield stress data for gels containing Kraton G1702 are given in Table IV. These data show that to obtain a given critical yield stress, the rubber level with Kraton G1702 can be reduced about 15% relative to Kraton G1701. Not coincidentally, the EP rubber block content of Kraton G1702 is approximately 15% larger than that of Kraton G1701. This fact suggests that if blends of the two rubbers are used, the total EP block content should be considered.

TABLE IV
Properties of Gels Containing Kraton ®^{a} G 1702
and Synthetic Oils

| | FORMULA ID: | | |
|---|---|---|---|
| | 13 | 14 | 15 |
| Kraton ® G1702, % | 10.0 | 8.0 | 7.5 |
| Oil Type, % | G, 88.8 | G, 90.7 | B, 91.3 |
| T Bar Visc, Reading @RT | 65.5 | 38.5 | 28.1 |
| Brookfield RVT, TB, 0.5 rpm | | | |
| Critical Yield Stress^{b}, Pa | | | |
| @ 23° C. | | 30 | 22 |
| @ 80° C. | | 22 | |
| Oil Separation, % | | | |
| ASTM D 6184 | | | |
| 30 hrs. @ 100° C. | | 0 | |
| 24 hrs. @ 150° C. | | 0 | |
| Screen Flow Test^{c} | | | |
| Modified ASTM D6184 | | | |
| Pass, ° C. | | 170 | |
| Fail, ° C. | | 180 | |
| Screen Evap Test^{c}, % | | | |
| Modified ASTM D6184 | | | |
| @ 150° C., % | | 0.09 | |
| PP1 Weight Gain, % | | | |
| @ 80° C. | | 6.9 | 6.6 |

^{a}Trade Name of Kraton Polymers LLC
^{b}Brookfield HBDV II+ C/P Spindle CP41, 0.1 RPM
^{c}24 hour at temp.

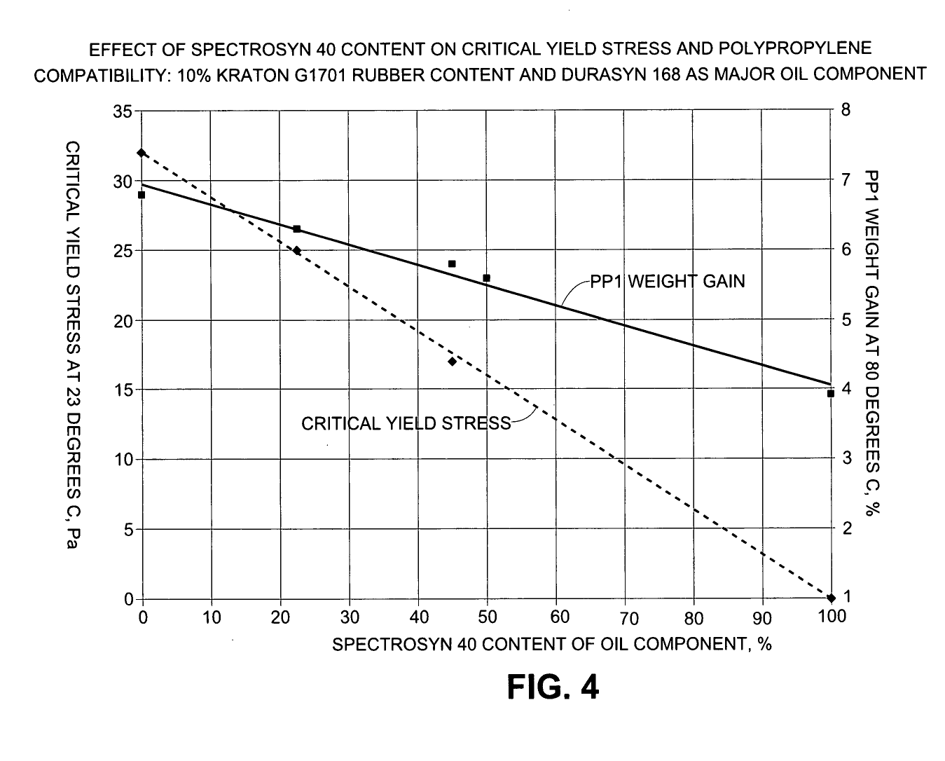

The critical yield stress data using blends of oils are shown in Table V. Of particular interest are gels 18 and 19 where oil G, Mn 609, is combined with oil D, Mn 1758. Both gels have a 10% rubber content. These critical yield stress data are plotted along with data for gel 10 in FIG. 4 as a function oil D content. Also plotted in FIG. 4 is the weight gain at 80° C. of PP1 as a function of oil D content. Included in this latter plot is the weight gain of a 50/50 mix of oil B and D. Oil and oil G are similar in their respective properties.

TABLE V
Properties of Gels Containing Kraton G1701 and Oil Blends

| | FORMULA ID: | | | |
|---|---|---|---|---|
| | 16 | 17 | 18 | 19 |
| Kraton ® G1701, % | 10.0 | 10.0 | 10.0 | 10.0 |
| Oil Type, % | F, 31.1 | C, 71.0 | G, 68.7 | G, 48.5 |
| Oil Type, % | E, 57.7 | J, 17.7 | D, 20.0 | D, 40.0 |
| Antioxidant, % | 1.2 | 1.3 | 1.3 | 1.5 |
| T Bar Visc, Reading @ RT | 37.9 | 39.5 | 26.1 | 20.2 |
| Brookfield RVT, TB, 0.5 rpm | | | | |
| Critical Yield Stress^{b}, Pa | | | | |
| @ 23° C. | 38 | 30 | 25 | 17 |
| Oil Separation. % | | | | |
| ASTM D 6184 | | | | |
| 30 hrs. @ 100° C. | | | 0 | 49 |
| 24 hrs. @ 150° C. | | | 2.4 | |
| Screen Flow Test^{c} | | | | |
| Modified ASTM D6184 | | | | |
| Pass, ° C. | | 170 | 140 | d |
| Fail, ° C. | | 178 | 150 | 80 |
| Screen Evap Testc, % | | | | |
| Modified ASTM D6184 | | | | |
| @ 150° C. | | 0.61 | 0.27 | |
| PP1 Weight Gain. % | | | | |
| @ 80° C. | | 6.0 | 6.3 | 5.8 |

a. Trade Name of Kraton Polymers LLC
^{b}Brookfield HBDV II+ C/P Spindle CP41, 0.1 RPM
^{c}24 hour test at temp.
d. not determined

Also note in Table V that blend 17, which contains polybutene oil J, does not show a significant decrease in critical yield stress relative to blend 6 in Table III. Therefore, polybutene oil can be added to the blend to either reduce cost or provide hydrogen absorption capability without degrading the critical yield stress. The Mn of the polybutene oil should be above that of the PAO oil. The amount added will be limited by the increased tack and lowered oxidative stability caused by the addition of the polybutene oil.

As can be seen, the improvement attained in weight gain by blending with oil D is offset by a reduction in critical yield stress. In fact, the same weight gain result could be obtained using oil C in place of the blended oils used in gel 18 without a decrease in critical yield stress. If, however, it was necessary to do the blending as in gel 18, an additional 1% of rubber could be added to correct the decrease in critical yield stress.

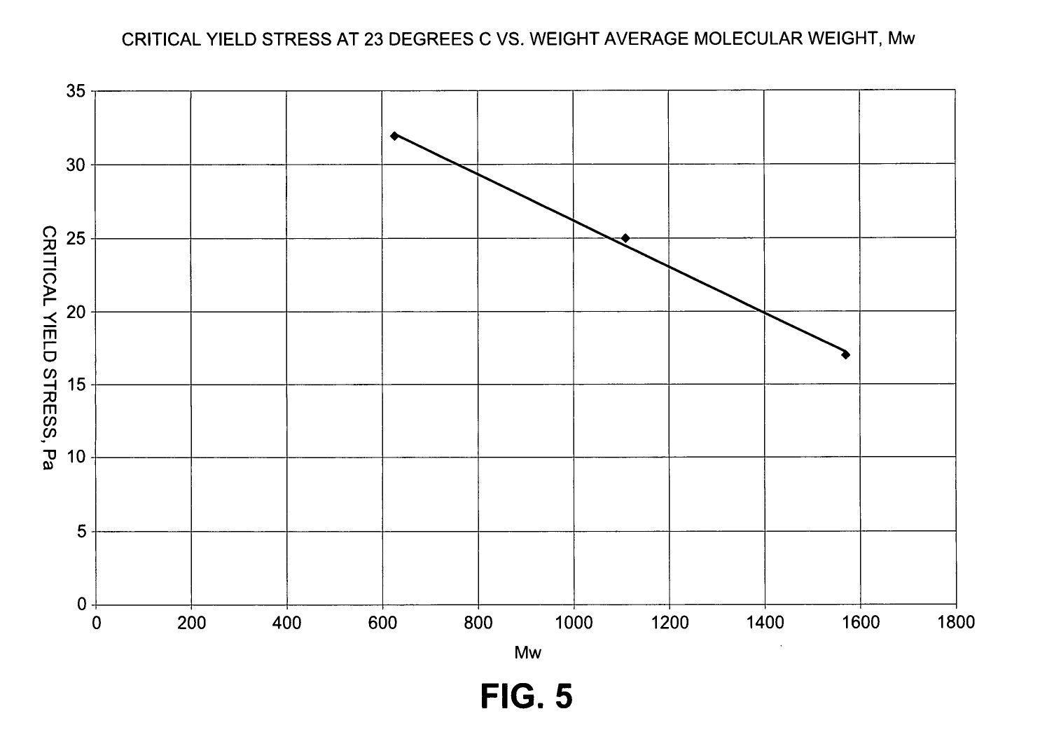

The reason for the decrease in critical yield stress can be seen in FIG. 5 where critical yield stress of gels 10, 18 and 19 are plotted versus weight average molecular weights, Mw, of the oils. Note that although gels 10 and 18 have the same Mn, the respective Mw values are very different.

The final test conducted on the gels was ASTM D6184, also known as the Conical Sieve Method. Two variations of this test were run, one using the conical sieve as specified and one using a modified sieve. In the modified test the screen was 40 mesh versus 60 mesh in the standard sieve and the cone was formed from a 270 degrees of the circular screen versus 180 degrees in the standard test. In both tests 10 g of gel weighed to the nearest mg was placed in the sieve. In the standard test, the sieve, supported on a glass beaker, was placed in a 100° C. oven for 30 hours. If no oil or gel passed through the sieve the temperature was raised to 150° C. for 24 hours. The amount of material passing through the sieve was determined and reported as a percent of the initial 10 g placed in the sieve.

In the modified test, the gel was exposed for 24 hours each to progressively increasing test temperature. The highest temperature for which no gel passed through the sieve was recorded. The evaporation from the gel after 24 hours exposure at 150° C. was also recorded. The test results from both the standard and modified test are shown in Tables III, IV and V.

Although the data is reported as oil separation, no actual oil separation was observed. Rather, material passing through the screen was gel. This flow resulted from a decrease in critical yield stress to the point where the gel could pass through the screen. Comparison of critical yield stress data with the data from the conical sieve tests suggests that a critical yield stress at 80° C. of about 16 Pa is required for no gel to pass through the screen at that temperature. As gel passes through the cone, the critical yield stress required for the remaining gel to remain in the screen decreases. The data also show that resistance to flow at temperatures in the 180° C. range can be attained if the critical yield stress at room temperature is above 40 Pa. No significant evaporation was seen in any gel.

Based on all these data, the preferred choice of a PAO oil would have an Mn of about 800 to 900 and an Mw of less than 1000. However, because such oils are not commercially available at this time, the best alternative oil would consist of a blend of PAO oil having an Mn of 600 to 720 and a polydispersity of less than about 1.1 with a PAO oil having an Mn of about 1750 and a polydispersity of about 1.7. The reduction in critical yield stress caused by the inclusion of a high Mw can be corrected by increasing the rubber content. An addition of about 0.5% rubber is required for each 10% addition of high Mw oil.

The rubber content required for a given critical yield stress varies with the rubber type. In blends containing Kraton G1701 with PAO oils having a low polydispersity and no high Mw oil, a rubber content between about 8.5% and 11% is useful. Where Kraton G1702 is used, the rubber content and be reduced about 15%. As previously discussed, if an oil such as D is included in the oil make-up, the rubber content must be adjusted.

In order to reduce the raw material cost up to about 30% of a PB oil having an Mn between about 900 and 1300 can be added.

All the gel compositions will require an antioxidant. The range is about 0.1 to 2%. Gels containing unsaturated PB oil will require the most antioxidant.

Additional ingredients sometimes included in the oil compositions are a fungicide, a palladium or platinum catalyst to increase the rate of hydrogen absorption in gels containing PB oil and hollow microspheres to reduce gel density.

None of the gels require fumed silica to be functional as optical fiber cable filling compositions. Inclusion of fumed silica will increase the cost of the gel.

The previous description is provided to enable any person skilled in the art to practice the various embodiments described herein. Modifications to these embodiments will be readily apparent to those skilled in the art; and generic principles defined herein may be applied to other embodiments. Although the present products have been described with reference to specific details of certain embodiments, it is not intended that such details be regarded as limitations upon the scope of the invention except as and to the extent they are included in the accompanying claims.

What is claimed is:

1. A filling composition for optical fiber cable, comprising
a) 7.5% to 11% by weight of a styrene(S)/ethylene-propylene (EP) di-block copolymer rubber.
b) 57% to 92% by weight of a polyalphaolefin oil or mixture of oils selected primarily from poly n-decene, poly n-dodecene and poly n-tetradecene wherein the weight average molecular weight is below about 1400.
c) 0% to 30% of a polybutene oil having a number average molecular weight greater than 900
d) 0.1% to 2% by weight of a thermal oxidative stabilizer.

2. A filling composition for optical fiber cable compatible with polypropylene copolymer sheath, comprising
a) 7.5% to 11% by weight of a styrene(S)/ethylene-propylene (EP) di-block copolymer rubber having a S/EP ratio of from 37/63 to 28/72.
b) 57% to 92% by weight of a polyalphaolefin oil or mixture of oils selected primarily from poly n-decene, poly n-dodecene and poly n-tetradecene wherein the number average molecular weight of the oil or each component of the oil mixture is between about 600 and 1000 and the polydispersity is less than about 1.1.
c) 0% to 30% by weight of a poly n-decene polyalphaolefin oil having a number average molecular weight of about 1750 and a polydispersity of about 1.7 wherein the resultant blend of (c) with (b) has a number average molecular weight greater than about 800 and a weight average molecular weight less than about 1400.
d) 0.1% to 2% by weight of a thermal oxidative stabilizer.

3. The filling composition of claim 2 wherein up to about 30% of the polyalphaolefin oil or oil blend is replaced with an equivalent amount of polybutene oil having a number average molecular weight between about 900 and 1300.

4. The optical fiber cable containing the filling composition of claim 1.

5. The optical fiber cable containing the filling composition of claim 2.

6. The optical fiber cable containing the filling composition of claim 3.

7. An article of manufacture containing the composition of claim 1.
